(19) United States
(12) Patent Application Publication
(10) Pub. No.: US 2024/0318826 A1
(43) Pub. Date: Sep. 26, 2024

(54) OVEN

(71) Applicant: Guangdong Enaiter Electrical Appliance Co. Ltd., Zhongshan (CN)

(72) Inventors: Zhibin MAI, Foshan (CN); Bufeng XU, Zhongshan (CN); Jingfeng WAN, Heze (CN)

(73) Assignee: Guangdong Enaiter Electrical Appliance Co. Ltd., Zhongshan (CN)

(21) Appl. No.: 18/303,762

(22) Filed: Apr. 20, 2023

(30) Foreign Application Priority Data
Mar. 23, 2023 (CN) 202310297686.4

(51) Int. Cl. F24C 7/08; F24C 7/06; F24C 15/00; F24C 15/02

(52) U.S. Cl. CPC F24C 7/085; F24C 7/067; F24C 15/007; F24C 15/022

(57) ABSTRACT

The present invention relates to an oven, including a box body, a middle spacer, a second heating module, a first heating module, a first door body, a second door body, a detection device, and a controller. The box body has a cooking cavity. The middle spacer is vertically arranged in a middle of the cooking cavity, and is detachably and fixedly connected to the box body, to selectively divide the cooking cavity into a first small cavity and a second small cavity. The second heating module and the first heating module can work independently of each other. The detection device is arranged in the box body or the middle spacer and is configured to detect whether the middle spacer is mounted in place and to generate a corresponding detection signal. The controller is arranged in the box body.

### CROSS-REFERENCE TO RELATED APPLICATIONS

The application claims priority to Chinese patent application No. 202310297686.4, filed on Mar. 23, 2023, the entire contents of which are incorporated herein by reference.

### TECHNICAL FIELD

The present invention relates to the technical field of household appliances, in particular to an oven.

### BACKGROUND

At present, common electric ovens may be single-cavity ovens and dual-cavity ovens according to the number of cooking cavities. A dual-cavity oven has two baking cavities each provided with a corresponding independent electric heating element, so that the two baking cavities can work independently of each other. Therefore, users may bake two different types of food at the same time without taint of odor, which makes the dual-cavity ovens popular among the public.

Some dual-cavity ovens have detachable middle spacers, to adaptively bake different sizes of food. The users switch a small cavity mode and a large cavity mode by mounting and dismounting the middle spacers, where the large cavity mode refers to a case where there are no middle spacers, and the small cavity mode refers to a case where there are middle spacers; then, the users manually adjust an operating mode of the ovens; and if the small cavity mode is used, the users also need to further select whether one or both of two electric heating elements operate. Sometimes, the users perform operation improperly or carelessly, causing the incorrect operating mode of the ovens. For example, in the large cavity mode, a single electric heating element is selected to operate, resulting in half of food being cooked and the other half being semi-cooked or raw, which greatly reduces the user experience.

### SUMMARY

To solve the above problems, the present invention provides a dual-cavity and dual-door oven, which can automatically recognize whether a middle spacer is mounted in place, and switch a small cavity mode and a large cavity mode, so that the operation is more convenient and easier.

The present invention provides a dual-cavity and dual-door oven, including a box body, a middle spacer, a second heating module, a first heating module, a first door body, a second door body, a detection device, and a controller. The box body has a cooking cavity. The middle spacer is arranged in a middle of the cooking cavity, and is detachably and fixedly connected to the box body, to selectively divide the cooking cavity into a first small cavity and a second small cavity. The first heating module is arranged in the first small cavity. The second heating module is arranged in the second small cavity. The second heating module and the first heating module can work independently of each other. The detection device is configured to detect whether the middle spacer is mounted in place and to generate a corresponding detection signal. The detection device, the first heating module, and the second heating module are electrically connected to the controller. The controller switches between a small cavity mode and a large cavity mode according to the detection signal, and when the middle spacer is mounted in place, the controller controls the oven to be in the small cavity mode.

The oven according to the embodiment of the present invention has at least the following beneficial effects: the detection device is added to automatically recognize whether the middle spacer is mounted in place: once it is detected that the middle spacer is mounted in place, the detection device sends a mounted-in-place signal to the controller, and the controller controls an operating mode of the oven to be the small cavity mode after receiving the mounted-in-place signal: when it is detected that the middle spacer is not mounted in place, the controller controls the operating mode of the dual-cavity and dual-door oven to be the large cavity mode after receiving a not-mounted-in-place signal; and in the large cavity mode, both the first heating module and the second heating module operate, so that the user operation is more convenient and easier, and the incidence of error events is reduced.

According to some embodiments of the present invention, a thermal insulation cavity is arranged in the middle spacer, and the thermal insulation cavity is located between the first small cavity and the second small cavity.

According to some embodiments of the present invention, a plurality of first brackets arranged at intervals are arranged in the thermal insulation cavity, each of the first brackets has one end connected to a first side wall of the thermal insulation cavity and the other end connected to a second side wall of the thermal insulation cavity, and the second side wall is arranged opposite to the first side wall.

According to some embodiments of the present invention, the middle spacer includes a first plate and a second plate arranged opposite to each other, the first plate has a first flange, the second plate has a second flange, the second flange is arranged against the first flange, and each of the first brackets has the one end connected to the first plate and the other end connected to the second plate.

According to some embodiments of the present invention, the box body is provided with a first guide rail and a second guide rail in cooperation with the middle spacer.

According to some embodiments of the present invention, the middle spacer is vertically arranged, and second brackets for supporting an electric heating element of the first heating module or the second heating module are arranged on two sides of the first guide rail.

According to some embodiments of the present invention, the detection device includes a microswitch.

According to some embodiments of the present invention, the oven further includes a first door body and a second door body, where the first door body opens or closes the first small cavity: the second door body opens or closes the second small cavity; and the first door body and the second door body are provided with a locking element, respectively, the box body is provided with corresponding door hooks, and each of the door hooks cooperates with a corresponding one of the locking elements in an inserted manner to lock or unlock the first door body or the second door body.

According to some embodiments of the present invention, the locking element includes a mounting portion, a first elastic clamping jaw, and a second elastic clamping jaw, one end of the first elastic clamping jaw and one end of the second elastic clamping jaw are connected to the mounting portion, the other end of the first elastic clamping jaw and the other end of the second elastic clamping jaw are arranged opposite to each other and are provided with stopper portions to form clamping grooves, the door hooks are provided with stopper matching portions, and when the door hooks are inserted into the clamping grooves, the stopper matching portions abut against the stopper portions to restrict movement of the door hooks.

According to some embodiments of the present invention, the small cavity mode includes a first small cavity mode, a second small cavity mode, and a third small cavity mode; in the first small cavity mode, the first heating module operates, and the second heating module does not operate: in the second small cavity mode, the first heating module does not operate, and the second heating module operates; and in the third small cavity mode, both the first heating module and the second heating module operate.

The additional aspects and advantages of the present invention will be partially given in the description below, and part of them will become apparent from the description below or will be learned from the practice of the present invention.

### BRIEF DESCRIPTION OF DRAWINGS

The present invention is further described below in conjunction with the accompanying drawings and the embodiments, in which:

FIG. 1 is a schematic three-dimensional view of an oven according to the embodiment of the present invention;

FIG. 2 is a schematic three-dimensional view of a partial structure of the oven shown in FIG. 1:

FIG. 3 is another schematic diagram of the oven shown in FIG. 2;

FIG. 4 is a schematic sectional view of FIG. 1;

FIG. 5 is a schematic structural diagram of a first door body or a second door body in FIG. 1:

FIG. 6 is a schematic enlarged view of local A in FIG. 5;

FIG. 7 is a schematic structural diagram of a locking element in FIG. 5;

FIG. 8 is a schematic structural diagram of a middle spacer in FIG. 1:

FIG. 9 is a schematic sectional view of FIG. 8; and

FIG. 10 is a schematic enlarged view of local B in FIG. 3.

Reference numbers in the accompanying drawings: box body 100; second support rib 110; second bracket 120; door hook 130; first guide rail 140; second guide rail 150; stopper matching portion 131: middle spacer 200; first bracket 210; first plate 220; first support rib 221; second plate 230; first heating module 300; motor 310; upper heating tube 320; lower heating tube 330; second heating module 400; first door body 500; locking element 510; mounting portion 511: first elastic clamping jaw 512; stopper portion 5121: second elastic clamping claw 513; second door body 600; detection device 700; microswitch 710; controller 800; operation panel 810; and knob 820.

### DETAILED DESCRIPTION OF THE EMBODIMENTS

The embodiments of the present invention are described in detail below: The examples of the embodiments are shown in the accompanying drawings, in which the same or similar reference numbers represent the same or similar elements or elements with the same or similar functions throughout. The embodiments described below with reference to the accompanying drawings are exemplary and only intended to explain the present invention, and cannot be construed as a limitation to the present invention.

In the description of the present invention, it should be understood that the description of orientations is involved, for example, the orientational or positional relationship indicated by the term such as “front”, “rear”, “up”, “down”, “left”, or “right” is based on the orientational or positional relationship shown in the accompanying drawings, merely for the convenience of describing the present invention and simplifying the description, rather than indicating or implying that the device or element referred to must have a particular orientation or be constructed and operated in a particular orientation, and therefore cannot be understood as a limitation to the present invention. In addition, the terms “first” and “second” are only used for descriptive purposes, and cannot be construed as indicating or implying relative importance or implying the number of technical features indicated. Thus, the features defined with “first” and “second” may explicitly or implicitly include one or more of the features.

In the description of the present invention, the terms such as “arranged”, “mounted”, and “connection” should be understood in a broad sense, unless otherwise explicitly defined. For example, “connection” may be fixed connection, detachable connection, or integrated connection; and “connected” may be directly connected or indirectly connected by an intermediate medium. Those skilled in the art may reasonably determine the specific meanings of the above terms in the present invention in combination with the specific content of the technical solution.

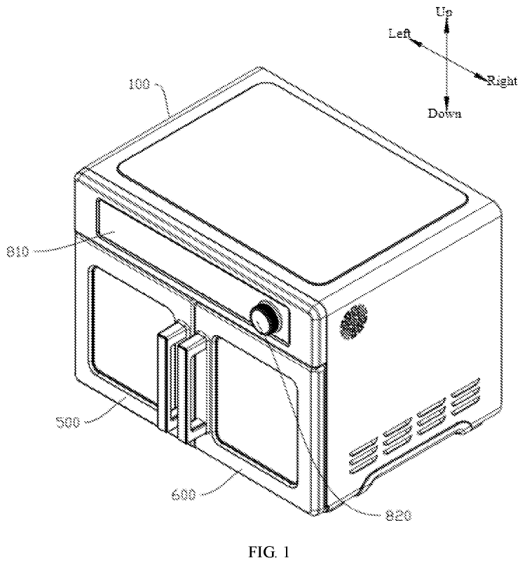

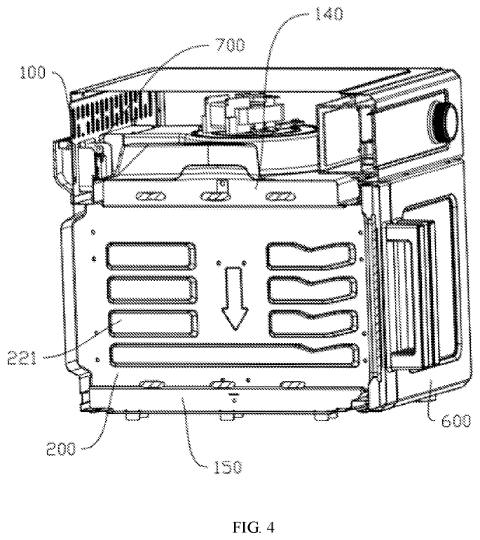

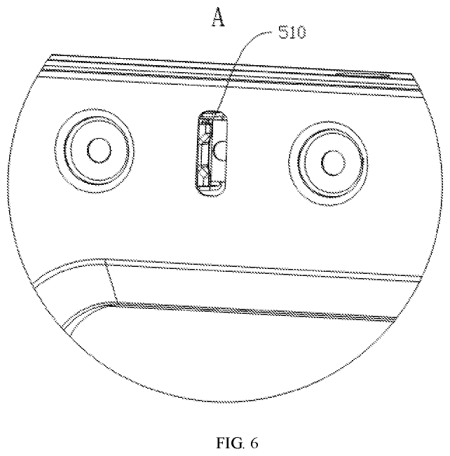

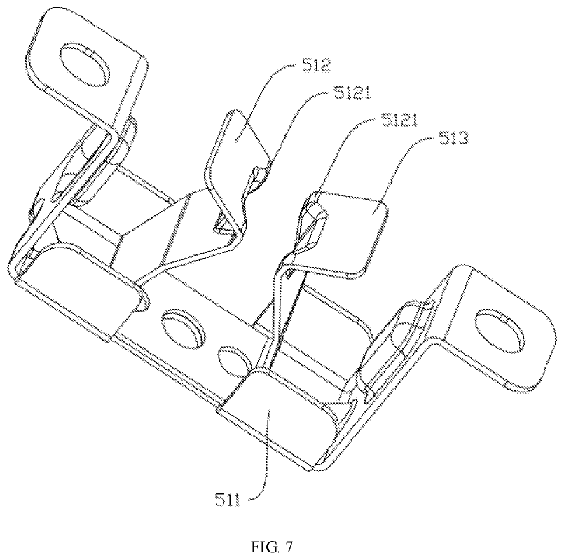

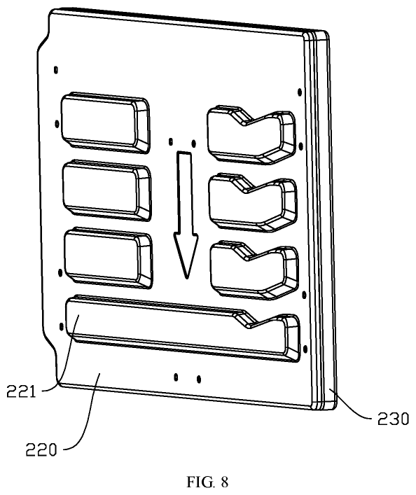

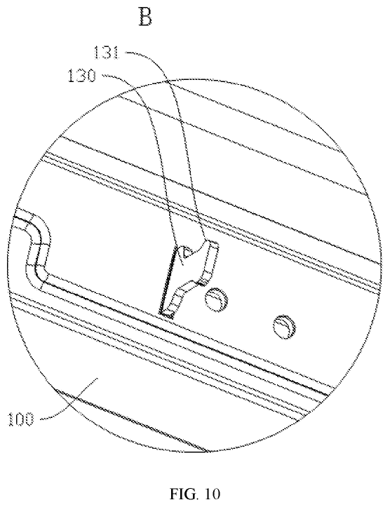

An oven provided according to the embodiment of the present invention is described below with reference to FIG. 1 to FIG. 10, including a box body 100, a middle spacer 200, a first heating module 300, a second heating module 400, a first door body 500, a second door body 600, a detection device 700, and a controller 800.

The box body 100 is square and has a cooking cavity of a transversely arranged rectangular structure inside. The middle spacer 200 is vertically arranged in a middle of the cooking cavity, and is detachably and fixedly connected to the box body 100, to selectively divide the cooking cavity into a first small cavity and a second small cavity, that is, when located in the cooking cavity, the middle spacer 200 divides the cooking cavity into the first small cavity and the second small cavity, and when not located in the cooking cavity, the middle spacer 200 does not have an impact on the cooking cavity. The middle spacer 200 is made of a high-temperature-resistant food grade metal material, which can better prevent the temperatures and odors of the first small cavity and the second small cavity from affecting each other.

The first heating module 300 is arranged in the first small cavity, to heat air and food in the first small cavity. The second heating module 400 is arranged in the second small cavity, to heat air and food in the second small cavity. Each of the second heating module 400 and the first heating module 300 includes a motor 310, an upper heating tube 320, and a lower heating tube 330. The second heating module 400 and the first heating module 300 can work independently of each other, that is, the second heating module 400 and the first heating module 300 can be switched on and off separately, and the switch-on temperatures and durations of the second heating module 400 and the first heating module 300 may also be separately controlled, so that in actual use, if two types of food need to be heated simultaneously, different ingredients may be added to the first small cavity and the second small cavity, respectively, for heating: and of course, the same ingredients may also be added to both the first small cavity and the second small cavity, but the operating temperatures or durations of the second heating module 400 and the first heating module 300 are different, to produce different tastes. When both the first small cavity and the second small cavity are not convenient for placing heated food, a user may dismount the middle spacer 200 and use a large cavity mode for baking.

The first door body 500 is connected to the box body 100, to open or close the first small cavity: The second door body 600 is connected to the box body 100, to open or close the second small cavity. The first door body 500 and the second door body 600 can work independently of each other.

The detection device 700 is arranged in the box body 100 and is configured to detect whether the middle spacer 200 is mounted in place and to generate a corresponding detection signal. The controller 800 is arranged in the box body 100. The detection device 700, the first heating module 300, and the second heating module 400 are electrically connected to the controller 800. The controller 800 automatically switches between a small cavity mode and the large cavity mode according to the detection signal, and when the middle spacer 200 is mounted in place, the controller 800 controls the oven to be in the small cavity mode, where the small cavity mode includes a first small cavity mode, a second small cavity mode, and a third small cavity mode. Of course, the detection device 700 may also be arranged in other position, such as the middle spacer 200 or the door body.

According to the present invention, whether the middle spacer 200 is mounted in place is automatically recognized by adding the detection device 700. Once it is detected that the middle spacer 200 is mounted in place, the detection device 700 sends a mounted-in-place signal to the controller 800, and the controller 800 controls an operating mode of the oven to be the small cavity mode after receiving the mounted-in-place signal. An operation panel 810 of the controller 800 displays the first small cavity mode, the second small cavity mode, and the third small cavity mode. The user selects one of the modes for operation by a knob 820. When it is detected that the middle spacer 200 is not mounted in place, the controller 800 controls the operating mode of the oven to be the large cavity mode after receiving a not-mounted-in-place signal. In the large cavity mode, both the first heating module 300 and the second heating module 400 operate, so that the user operation is more convenient and easier, and the incidence of error events is reduced.

It should be noted that the cooking cavity may also be in other shape, such as a vertical cuboid or a square cylinder; the middle spacer 200 may also be transversely or obliquely placed in the cooking cavity: there may be one door body for opening or closing the cooking cavity; and the controller 800 may also be arranged in other position, such as the first door body 500 or the second door body 600.

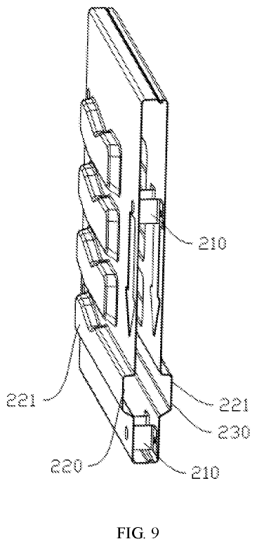

In some specific embodiments of the present invention, referring to FIG. 9, a thermal insulation cavity is arranged in the middle spacer 200, and the thermal insulation cavity is located between the first small cavity and the second small cavity. The heat transfer between the first small cavity and the second small cavity is blocked by air, thereby reducing the heat loss rate. Meanwhile, a temperature difference between the first small cavity and the second small cavity may be large, thereby improving the heat utilization and expanding the applicable range of the product.

In some specific embodiments of the present invention, referring to FIG. 9, a plurality of first brackets 210 arranged at intervals are arranged in the thermal insulation cavity, each of the first brackets 210 has one end connected to a left side wall of the thermal insulation cavity and the other end connected to a right side wall of the thermal insulation cavity, and the left side wall is arranged opposite to the right side wall. By adding the first brackets 210, the structural strength of the middle spacer 200 is improved, and the deformation of the middle of the middle spacer 200 is prevented, thereby avoiding the situation that first support ribs 221 configured to support a tray and located on the middle spacer 200 are not flush with second support ribs 110 on a side wall of the cooking cavity.

In some specific embodiments of the present invention, referring to FIG. 9, the middle spacer 200 includes a first plate 220 and a second plate 230 arranged opposite to each other, the first plate 220 has a first flange, the second plate 230 has a second flange, the second flange is arranged against the first flange, and each of the first brackets 210 has one end connected to the first plate 220 and the other end connected to the second plate 230, so that the structure is simple, the assembly is convenient, and the entry of foreign matter to the middle spacer 200 is reduced.

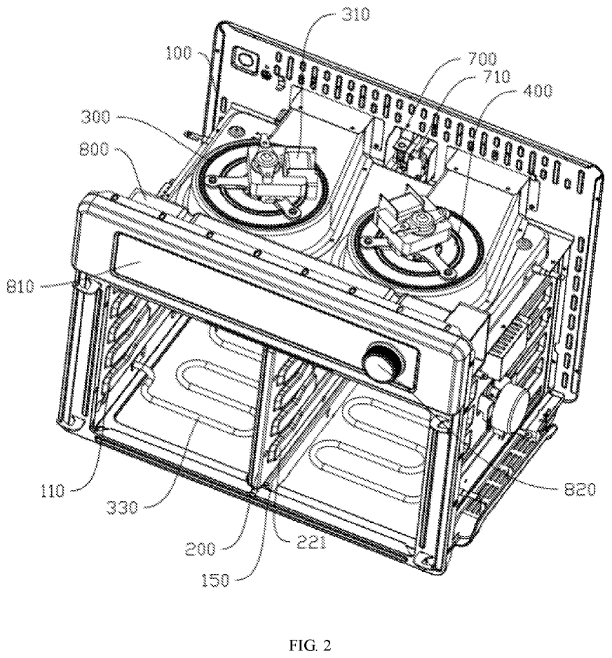

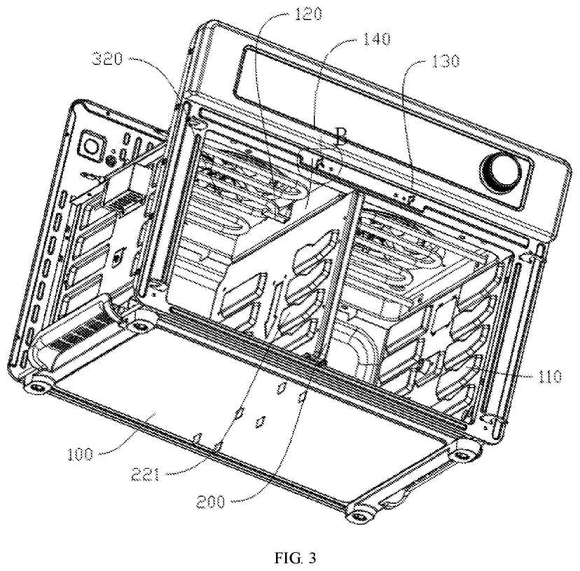

In some specific embodiments of the present invention, referring to FIGS. 2 to 3, the box body 100 is provided with a first guide rail 140 and a second guide rail 150 in cooperation with the middle spacer 200. The first guide rail 140 and the second guide rail 150 have the effects of positioning and guiding the middle spacer 200, so that the middle spacer 200 is slidably inserted in the cooking cavity, thereby lowering the assembly difficulty and making it more convenient for the user to mount or dismount the middle spacer 200.

In some specific embodiments of the present invention, referring to FIG. 3, second brackets 120 for supporting an upper heating tube 320 of the first heating module 300 or the second heating module 400 are arranged on two sides of the first guide rail 140, so that the upper heating tube 320 can be well fixed.

In some specific embodiments of the present invention, referring to FIG. 2, the detection device 700 includes a microswitch 710. The microswitch 710 is mounted on the box body 100. When in a state of being mounted in place, the middle spacer 200 is in contact with the microswitch 710 and triggers the microswitch 710. When not in the state of being mounted in place, the middle spacer 200 is disconnected from the microswitch 710, thereby implementing the detection of whether the middle spacer 200 is in the state of being mounted in place. The microswitch is simple in structure, easy to produce, and low in cost. Of course, the detection device 700 may also be in other form, such as a pressure sensor or a Hall sensor.

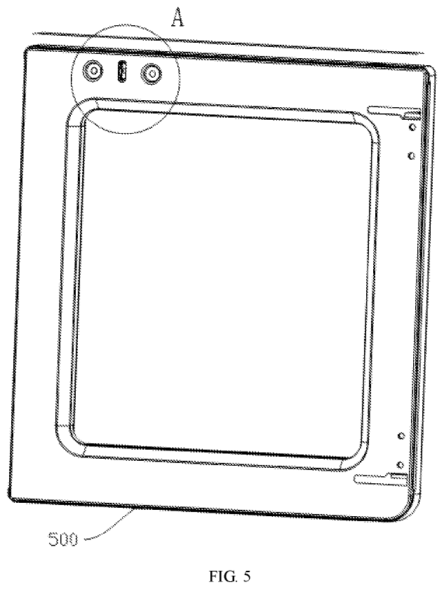

In some specific embodiments of the present invention, referring to FIG. 3, FIGS. 5 to 7, and FIG. 10, the first door body 500 and the second door body 600 are provided with a locking element 510, respectively, the box body 100 is provided with corresponding door hooks 130, and each of the door hooks 130 cooperates with a corresponding one of the locking elements 510 in an inserted manner to lock or unlock the first door body 500 or the second door body 600. Compared with a method for locking the door body by a strong magnet, the method for locking the door body by the locking element 510 and the door hook 130 in this application has the advantages of longer service life and lower cost.

In some specific embodiments of the present invention, referring to FIG. 3, FIGS. 5 to 7, and FIG. 10, the locking element 510 includes a mounting portion 511, a first elastic clamping jaw 512, and a second elastic clamping jaw 513, one end of the first elastic clamping jaw 512 and one end of the second elastic clamping jaw 513 are connected to the mounting portion 511, the other end of the first elastic clamping jaw and the other end of the second elastic clamping jaw are arranged opposite to each other and are provided with stopper portions 5121 to form clamping grooves, the door hooks 130 are provided with stopper matching portions 131, and when the door hooks 130 are inserted into the clamping grooves, the stopper matching portions 131 abut against the stopper portions 5121 to restrict movement of the door hooks 130, so that the structure is simple, efforts are saved, and locking and unlocking are facilitated.

In some specific embodiments of the present invention, the small cavity mode includes the first small cavity mode, the second small cavity mode, and the third small cavity mode; in the first small cavity mode, the first heating module 300 operates, and the second heating module 400 does not operate: in the second small cavity mode, the first heating module 300 does not operate, and the second heating module 400 operates; and in the third small cavity mode, both the first heating module 300 and the second heating module 400 operate. In addition to the large cavity mode, the dual-door and dual-cavity oven has at least four operating modes, can well meet different requirements of users, and has higher flexibility.

In the description of this specification, the description with reference to the term such as “one embodiment”, “some embodiments”, “schematic embodiments”, “examples”, “specific examples”, or “some examples” means that the specific features, structures, materials, or characteristics described in combination with this embodiment or example are included in at least one embodiment or example of the present invention. In this specification, the schematic representations of the above terms do not necessarily refer to the same embodiment or example. Moreover, the specific features, structures, materials or characteristics described may be combined in a suitable way in any one or more embodiments or examples.

Although the embodiments of the present invention have been shown and described, it may be understood by those of ordinary skill in the art that various changes, modifications, substitutions, and variations may be made to these embodiments without departing from the principle and objective of the present invention. The scope of the present invention is defined by the claims and their equivalents.

What is claimed is:

1. An oven, comprising:
a box body having a cooking cavity;
a middle spacer arranged in the cooking cavity, wherein the middle spacer is detachably and fixedly connected to the box body, to selectively divide the cooking cavity into a first small cavity and a second small cavity;
a first heating module arranged in the first small cavity;
a second heating module arranged in the second small cavity, wherein the second heating module and the first heating module are capable of working independently of each other;
a detection device configured to detect whether the middle spacer is mounted in place and to generate a corresponding detection signal; and
a controller, wherein the detection device, the first heating module, and the second heating module are electrically connected to the controller, the controller switches between a small cavity mode and a large cavity mode according to the detection signal, and when the middle spacer is mounted in place, the controller controls the oven to be in the small cavity mode.

2. The oven according to claim 1, wherein a thermal insulation cavity is arranged in the middle spacer, and the thermal insulation cavity is located between the first small cavity and the second small cavity.

3. The oven according to claim 2, wherein a plurality of first brackets arranged at intervals are arranged in the thermal insulation cavity, each of the first brackets has one end connected to a first side wall of the thermal insulation cavity and the other end connected to a second side wall of the thermal insulation cavity, and the second side wall is arranged opposite to the first side wall.

4. The oven according to claim 3, wherein the middle spacer comprises a first plate and a second plate arranged opposite to each other, the first plate has a first flange, the second plate has a second flange, the second flange is arranged against the first flange, and each of the first brackets has the one end connected to the first plate and the other end connected to the second plate.

5. The oven according to claim 1, wherein the box body is provided with a first guide rail and a second guide rail in cooperation with the middle spacer.

6. The oven according to claim 5, wherein the middle spacer is vertically arranged, and second brackets for supporting an electric heating element of the first heating module or the second heating module are arranged on two sides of the first guide rail.

7. The oven according to claim 1, wherein the detection device comprises a microswitch.

8. The oven according to claim 1, further comprising a first door body and a second door body, wherein the first door body opens or closes the first small cavity: the second door body opens or closes the second small cavity; and the first door body and the second door body are provided with a locking element, respectively, the box body is provided with corresponding door hooks, and each of the door hooks cooperates with a corresponding one of the locking elements in an inserted manner to lock or unlock the first door body or the second door body.

9. The oven according to claim 8, wherein the locking element comprises a mounting portion, a first elastic clamping jaw, and a second elastic clamping jaw, one end of the first elastic clamping jaw and one end of the second elastic clamping jaw are connected to the mounting portion, the other end of the first elastic clamping jaw and the other end of the second elastic clamping jaw are arranged opposite to each other and are provided with stopper portions to form clamping grooves, the door hooks are provided with stopper matching portions, and when the door hooks are inserted into the clamping grooves, the stopper matching portions abut against the stopper portions to restrict movement of the door hooks.

10. The oven according to claim 9, wherein the small cavity mode comprises a first small cavity mode, a second small cavity mode, and a third small cavity mode; in the first small cavity mode, the first heating module operates, and the second heating module does not operate; in the second small cavity mode, the first heating module does not operate, and the second heating module operates; and in the third small cavity mode, both the first heating module and the second heating module operate.
